(19) United States
(12) Patent Application Publication
(10) Pub. No.: US 2002/0194126 A1
(43) Pub. Date: Dec. 19, 2002

(54) Method and system for handling invoices

(76) Inventors: Wayne L. Randell, Oakville (CA); Leonard A. Podgurny, Mississauga (CA); Edward A. Widlake, Grimsby (CA)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 09/845,380

(22) Filed: Apr. 30, 2001

(51) Int. Cl. G06F 17/60

(52) U.S. Cl. 705/40; 705/39

(57) ABSTRACT

A method and system for handling a given invoice generated at a biller and destined to a customer entity is provided. First and second permission levels are provided at the biller and are associated to first and second respective users of the customer entity. The first permission level allows the first user to process invoices of a first type characterized by amounts in a first range of amounts and the second permission level allows the second user to process invoices of a second type characterized by amounts in a second range of amounts. Either one of the first user and the second user is enabled to process the given invoice over a network on the basis of their associated permission levels.

### FIELD OF THE INVENTION

This invention relates to a system and method for facilitating online commerce over a public network such as the Internet or an interactive T.V. cable network. More particularly, this invention relates to a system and method for conducting online processing of an invoice including invoice handling capabilities for multiple permission levels.

### BACKGROUND OF THE INVENTION

Online commerce has experienced dramatic growth in recent years and this growth is expected to continue into the coming decades. Internet service providers are, more and more, connecting users to the Internet at no cost, thus eliminating barriers to an Internet connection. At the same time, merchants are increasingly developing sites on the World Wide Web (or simply “WWW” or “Web”) that customers can access to order goods and/or services. It is now fairly common for a customer to browse a merchant's catalogue, select a product or service and place an order for the product/service all electronically over the Internet. Similarly, it is becoming increasingly common for merchants to allow payment of invoices electronically. Typically, the invoice is sent electronically to the customer via electronic mail or made available to the customer over a network by providing the customer with network access capability.

U.S. Pat. No. 6,128,603 issued to Dent et al. on Oct. 3, 2000) describes a consumer-based system for analyzing, managing and paying electronic bill statements received from a biller. The biller electronically transmits a customized statement to a consumer's computer terminal over the Internet. The biller's electronic bill is presented to the consumer through a user interface. After reviewing the electronic bill the consumer can enter how much of the bill to pay, from which account to pay from, and the desired payment date. The entered information is then transmitted to the biller for processing. The contents of U.S. Pat. No. 6,128,603 are incorporated herein by reference.

Similarly, U.S. Pat. No. 6,070,150, issued to Remington et al. on May 30, 2000, describes an electronic payment system in which a biller electronically transmits a bill to a consumer over the Internet. The bill may arrive at the consumer's terminal via email or a notification for the consumer to check a billing mailbox. The consumer receives the bill that can be displayed in the form of a user interface. After reviewing the bill the consumer is able to enter the amount to be paid, the date of payment and from which account the money can be taken. The system described in Remington et al. also includes the ability to let the consumer dispute an item in an invoice. The contents of U.S. Pat. No. 6,070,150 are incorporated herein by reference.

A deficiency with the above-described systems for the payment electronic of invoices is that they are ill suited to certain business-to-business environments. In a typical business setting, it is common to delegate to senior administrators the responsibility of approving invoices for small expenses such as paper supplies for example. Larger expenses however generally require the authorization of a director or vice president in a business. With the current systems, a first user, such as a senior administrator, typically processes an invoice at the client entity. If the invoice exceeds the first user's authority, then the first user forwards the invoice to a second user having a higher level of authorization for processing. From the biller's perspective, this process is time consuming and often results in delays in the payment of an invoice thereby resulting in an increase in the accounts payable turnover rate.

Consequently there exists a need in the industry to provide an improved system and method for handling invoices that alleviates at least in part the deficiencies of prior art systems and methods.

### SUMMARY

In accordance with a broad aspect, the invention provides a method for handling an invoice generated at a biller and destined to a customer entity, the customer entity including a first user and a second user. The method includes providing at the biller a first permission level and associating the first permission level to the first user of the customer entity. The first permission level allows the first user to process invoices of a first type. A second permission level is also provided at the biller and is associated to the second user. The second permission level allows the second user to process invoices of a second type. Either one of the first and the second user is enabled to process the given invoice over a network on the basis of their associated permission levels.

An advantage of the present invention is that it facilitates the involvement of individuals having different permission levels in the handling of an invoice. The different permission levels allow different users associated to a customer entity to be given different levels of responsibilities in the handling of an invoice.

In accordance with a specific implementation, the given invoice is characterized by a given amount, invoices of a first type are characterized by amounts in a first range of amounts and invoices of a second type are characterized by amounts in a second range of amounts. The given amount of the given invoice is compared with the first range of amounts to determine whether the given invoice is an invoice of the first type. In the affirmative, the first user is enabled to process the given invoice. The given amount is also compared to the second range of amounts to determine whether the given invoice is an invoice of the second type. In the affirmative the second user is enabled to process the given invoice.

Another advantage of the present invention is that it allows for at least two individuals to be permitted to process invoices having amounts in different ranges of amounts. It will be readily appreciated that more than two permission levels may be provided without detracting from the spirit of the invention.

In a specific example of implementation, the first range of amounts has a first lower boundary amount and a first upper boundary amount. Similarly, the second range of amounts has a second lower boundary amount and a second upper boundary amount, where the second upper boundary amount is greater than the first upper boundary amount.

In a non-limiting example of implementation, the first range of amounts and the second range of amounts are non-overlapping.

The first user is enabled to provide payment remittance information for the given invoice if the given invoice is an invoice of the first type and the second is enabled to provide payment remittance information for the given invoice if the given invoice is an invoice of the second type. The payment remittance information includes data selected from the set consisting of a credit card number, an authorization to debit a bank account, wire transfer information, direct deposit information, an amount to be paid on the invoice and an indication that a check will be mailed.

In a variant, the given invoice is associated to a given category selected from a plurality of categories, and the first and second users are assigned respective permission levels associated to respective categories.

In accordance with another broad aspect, the invention provides a computer readable medium including a program element executable by a computing apparatus for implementing the above described method.

In accordance with a broad aspect, the invention provides an electronic invoice presentment and payment remittance system including a biller computing unit, a first customer computing unit and a second customer computing, the system implementing the above-described method.

In accordance with another aspect, the invention provides a method and system for handling a given invoice generated at a biller and destined to a customer entity, the given invoice being characterized by a given amount. A plurality of permission levels is provided and associated to respective users of the customer entity. Each permission level allows the associated user to process invoices characterized by amounts in a range of amounts. For a given permission level, the given amount is compared with the range of amounts corresponding to the given permission level to determine whether the given permission level allows processing of the given invoice. The users in the plurality of users of the customer entity are selectively enabled to process the given invoice on the basis of the comparison.

Advantageously, the use of a plurality of permission levels allows the invoice presentment and payment remittance system to be better suited to large business environments.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

FIG. 1 is a block diagram of an electronic invoice presentment and payment remittance system in accordance with an embodiment of the invention, including a biller computing system 116, a network 106, and a customer computing system 150 having a plurality of computing units;

FIG. 2a is a block diagram depicting one of the customer computing units shown in FIG. 1 in accordance with an embodiment of the invention;

FIG. 2b is a block diagram depicting the biller computing system 116 shown in FIG. 1 in accordance with an embodiment of the invention;

FIG. 3 is a flow diagram of a registration phase for use in connection with a process for electronically presenting and granting payment of invoices in accordance with an example of implementation of the invention;

FIG. 4 is a flow diagram of the process for electronically presenting and granting payment of invoices in accordance with a specific example of implementation of the invention;

FIGS. 5a and 5b is a non-limiting example of implementation of a graphical user interface for presenting a plurality of unpaid invoices associated to a customer entity.

In the drawings, embodiments of the invention are illustrated by way of example. It is to be expressly understood that the description and drawings are only for purposes of illustration and as an aid to understanding, and are not intended to be a definition of the limits of the invention.

### DETAILED DESCRIPTION

The method and system for handling invoices provide multi-level permissions capabilities for invoice handling. The multi-level permissions allow different users associated to a customer entity to be given different levels of responsibilities in the handling of an invoice.

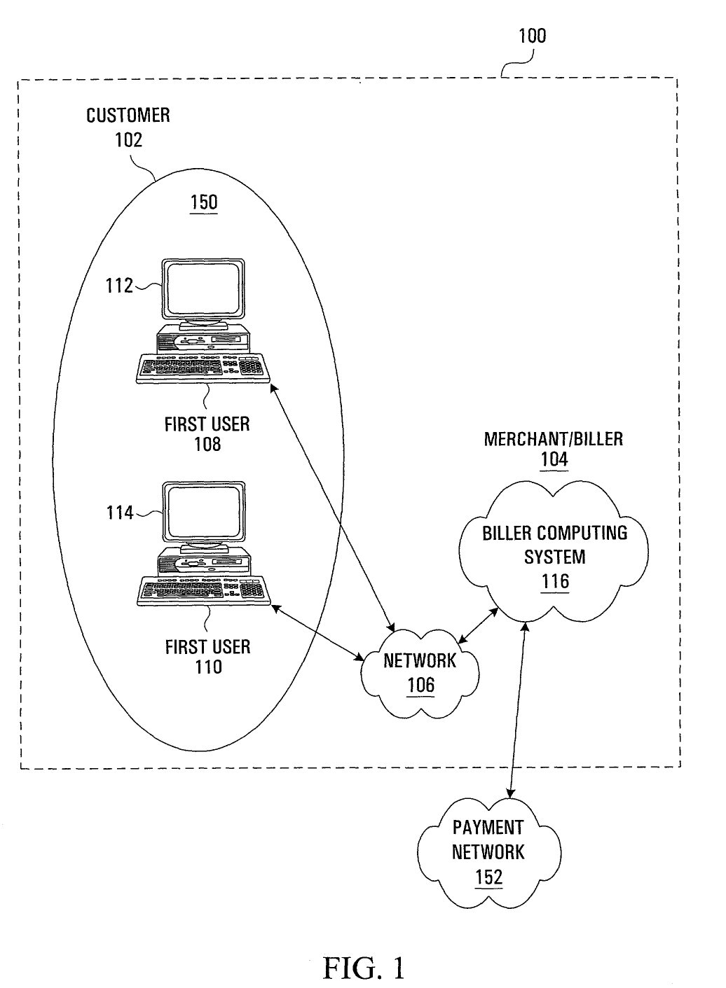

FIG. 1 shows an electronic invoice presentment and payment remittance system 100 in accordance with a specific implementation. The system 100 allows a customer entity 102 to view the state of its accounts payable with regards to a specific biller 104 and to issue payment instructions to that specific biller 104. The system 100 includes a biller computing system 116 and a customer computing system 150 interconnected through a network 106. The biller computing system 116 and the customer computing system 150 include tools for facilitating online commerce transactions between the customer entity 102 and the biller entity 104.

The network 106 is a data communication network interconnecting the customer computing system 150 and the biller computing system 116. In a specific example of implementation, the network is a public network. In the illustrated implementation, the data communication network 106 is embodied in the Internet. It is to be noted that the data communication network 106 may be implemented as a network other that the Internet such as an interactive television (ITV) network, a private network such as an Intranet or any other suitable network.

The customer computing system 150 comprises a plurality of computing units 112 114, each associated to a respective user 108, 110. The computing units 112 114 are generally in the form of personal computers, although other types of computing units may be used including laptops, notebooks, hand-held computers, set top boxes, and the likes. The plurality of computing units 112 114 may be connected to one another over an Intranet or may be stand-alone computing units. Each of the computing units 112 114 is provided with a connection to the network 106. The connection may be a permanent connection through a server at the customer's premises, or alternatively, a given computing unit may occasionally connect to the network 106 through the use of a dial-up connection using suitable devices such as a modem for example. For the purpose of simplicity, the example described herein below considers a customer computing system 150 including two customer computing units 112 114 each being respectively associated to a first user 108 and a second user 110. It will be readily appreciated that a customer computing system 150 including in excess of two customer-computing units remains within the invention.

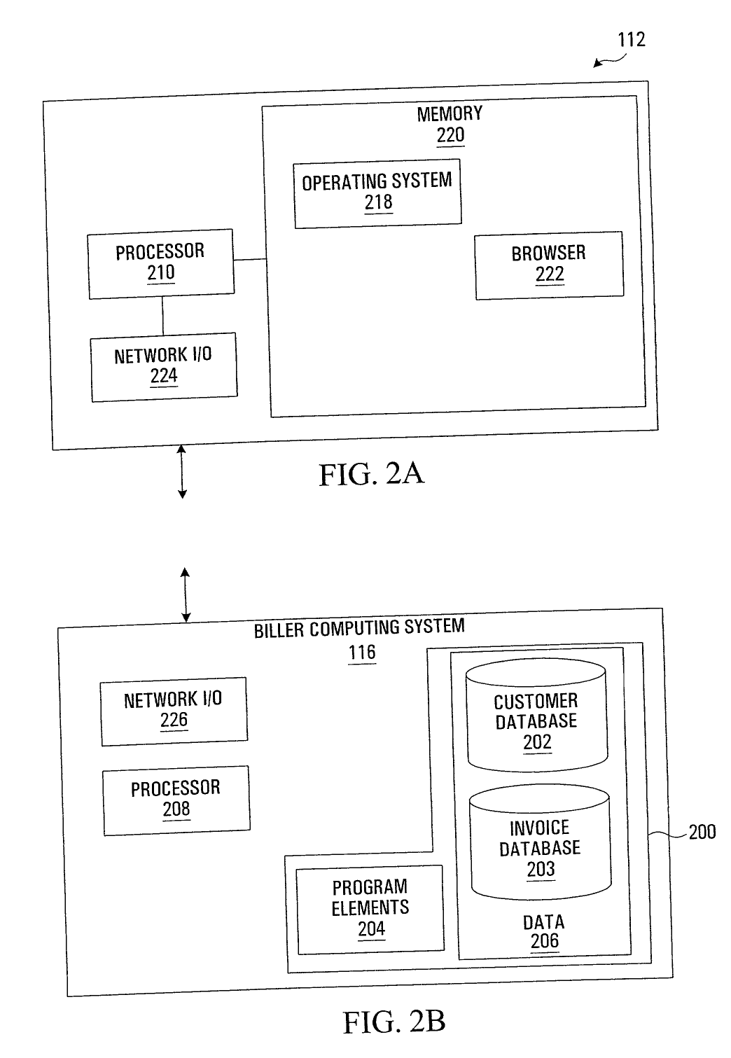

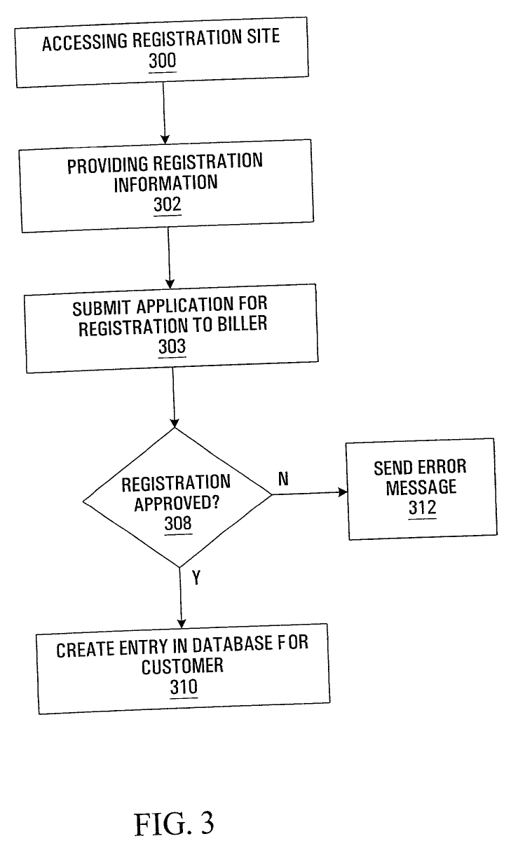

FIG. 2a depicts a block diagram of customer computing unit 112. The structure and functionality of customer computing unit 114 is identical to that of customer computing unit 112 and as such will not be described. As shown, the customer computing unit 112 comprises a processor 210, a memory 220 and a network I/O 224 (input/output) for accessing the network 106. The network I/O 224 can be implemented, for example, as a dial-up modem or as a permanent network connection. The processor 210 is adapted to execute program elements stored in the memory 220 for performing certain functions. More specifically, the customer computing unit 112 runs an operating system 218 that supports multiple applications. The operating system 218 is preferably a multitasking operating system that allows simultaneous execution of multiple applications in a graphical windowing environment. The memory 220 also includes a browser program element 222. The browser program element 222 when launched is executed by the processor 210 atop the operating system 218. The customer computer unit 112 may also include e-mail software components (not shown) as well as additional components and modules. These have been omitted from the description for the purpose of clarity.

The biller computing system 116 includes one or more computer servers and one or more computing apparatuses. The system includes program elements allowing the biller entity 104 to manage customer invoices and to provide electronic processing of invoices. The biller computing system 116 may also include modules for connection to a payment network 152 (shown in FIG. 1). The payment network 152 represents existing networks that presently accommodate transactions for credit cards, debit cards, checks and other types of financial payment processes. A description of the payment network 152 and of the interaction of the biller computing system 116 with the payment network 152 is not necessary for the understanding of the present invention and as such will not be described.

FIG. 2b is a block diagram of the biller computing system 116. As depicted, the biller computing system 116 comprises a processor 208, a memory 200 and a network I/O 226 (input/output) for connection to the network 106. The network I/O 226 is preferably implemented as a permanent network connection although dial up connections may be suitable in certain embodiments. For example, if the biller computing system 116 interacts with the customer computing system 150 via e-mail, then a dial-up connection may be suitable.

The processor 208 executes program elements 204 stored in the memory 200 for performing various functions. The memory 200 also has a data portion 206 including a customer database 202 and an invoice database 203. It will be readily appreciated that the biller computing system 116 may include additional components and modules. These have been omitted from the description for the purpose of clarity.

The customer database 202 includes information pertaining to the customers of the biller entity. This information is provided by the customer entity 102 to the biller 104 via a registration process. In a non-limiting implementation, for each customer entity, an entry is provided including various information data elements associated to the customer entity. Amongst others, each entry includes a plurality of records, each record including a user identifier with a corresponding password.

In addition, each user identifier is associated to a permission level describing the type of invoice the user associated to the user identifier is permitting to process. The table below is a representation of an entry in the customer database 202 for customer ABC INC. As shown, ABC INC. has five records for users (User1, User2, User3, User4, User5). User 3 has permission level 0, User2 has permission level 2, User1 has permission level 1, User4 has permission level 4 and User5 has permission level 2.

Customer ABC Inc. : User list

| User name | Password | Permission Level |
|---|---|---|
| User1 | 1234 | Level 1 |
| User2 | 9876 | Level 2 |
| User3 | 7656 | Level 0 |
| User4 | 5656 | Level 4 |
| User5 | 4321 | Level 2 |

The first user (User1) is associated to a first permission level (level 1) allowing the first user to process invoices of a first type and the second user (User2) is associated to a second permission level (level 2) allowing the second user to process invoices of a second type. In a non-limiting example, a range of amounts characterizes each type of invoice. In a specific implementation, invoices of a first type are characterized by amounts in a first range of amounts and invoices of a second type are characterized by amounts in a second range of amounts. More specifically, the first range of amounts has a first lower boundary amount and a first upper boundary amount and the second range of amounts has a second lower boundary amount and a second upper boundary amount. In this specific example the second upper boundary amount is greater than the first upper boundary amount.

The table below is a representation of the permission levels on the basis of the ranges of amounts. It will be readily appreciated that when the lower boundary of the range is a default value such as “0”, the lower boundary may be omitted.

| Level | Range |
|---|---|
| Level 0 | 0 . . . 499.99$ |
| Level 1 | 0 . . . 999.99$ |
| Level 2 | 0 . . . 4999.99$ |
| Level 3 | 0 . . . 9999.99$ |
| Level 4 | 0 . . . 10000$ and more |

In a non-limiting example, the permission levels allow a first user at the customer site to be permitted to approve invoices of up to a first amount limit; a second user permitted to approve invoices of up a second amount limit, the second amount limit being higher that the first amount limit; a third user permitted to approve invoices of up a third amount limit, the third amount limit being greater that the second amount limit; and so on. It is to be appreciated that the number of permission levels may vary from one customer to the other without detracting on the spirit of the invention and will generally be determined on the basis of the organizational style of the customer entity.

In another non-limiting example, the ranges of amounts assigned to the permission levels are non-overlapping as shown in the table below. Providing non-overlapping ranges avoids user having high permission level from being presented with all invoices and allows a streamlining of invoice handling at the customer site. For example, a user having permission level 4, which may be a high ranking manager in an organization, would only be presented with invoices in the range 10000$ and over.

| Level | Range |
|---|---|
| Level 0 | 0 . . . 499.99$ |
| Level 1 | 500 . . . 999.99$ |
| Level 2 | 1000 . . . 4999.99$ |
| Level 3 | 5000 . . . 9999.99$ |
| Level 4 | 10000$ and more |

As a variant, invoices issued by the biller are assigned to different categories and the levels of permissions are conditioned on the basis of the invoice category. For example, the categories may be based on the type of product/service offered by the biller or on the customer administrative department to which the invoice is destined amongst others. In this variant, each user identifier is associated to respective permission levels describing the type over invoice the user associated to the user identifier is permitting to process in a given category. The table below is a representation of an entry in the customer database for customer DEF INC. providing user permission levels on the basis of category. As shown, DEF INC. has two records for users (User1, User2). User1 has permission level 3 for invoices in the commodities category and the luxury items category and permission level 10 for invoices in the animal stock category. User2 has permission level 0 for invoices in the commodities category and permission level 4 for invoices in the luxury items category and the animal stock category.

Customer DEF Inc. : User list

| User name | Password | Category | Permission Level |
|---|---|---|---|
| User1 | 3434 | Commodities | Level 3 |
| | | Luxury items | Level 3 |
| | | Animal Stock | Level 0 |
| User2 | 2357 | Commodities | Level 0 |
| | | Luxury items | Level 4 |
| | | Animal Stock | Level 4 |

As yet another variant, each user identifier is assigned levels of permissions conditioned on the basis of respective privileges defining stages that the user is permitted to complete in a multi-stage invoice handling process. In a non-limiting example, the multi-stage invoice handling process includes a first stage and a second stage. The table below is a representation of an entry in the customer database for customer ABC INC. As shown, ABC INC. has three records for users (User1, User2, User3) for a two stage multi-stage invoice handling process. User1 has privileges to complete stage 1 of the multi-stage invoice handling process and a level-1 permission level. User2 has privileges to complete stage 2 of the multi-stage invoice handling process and a level-3 permission level. User3 has privileges to complete stage 1 of the multi-stage invoice handling process with a level-1 permission level and has permissions to complete stage 2 of the multi-stage invoice handling process with a level-4 permission level.

Customer ABC Inc. : User list

| User name | Password | Privileges | Permission Level |
|---|---|---|---|
| User1 | 1234 | Stage #1: Yes | Level 1 |
| | | Stage #2: No | Level 0 |
| User2 | 9876 | Stage #1: No | Level 0 |
| | | Stage #2: Yes | Level 3 |
| User3 | 7656 | Stage #1: Yes | Level 1 |
| | | Stage #2: Yes | Level 4 |

It will be readily apparent that other variations and permutations are possible without detracting from the spirit of the invention. For instance, the permission levels may be conditioned on the basis of the invoice category and the privileges defining stages that the user is permitted to complete.

It is also to be expressly understood that although the invoice database 202 has been depicted in the form of a table, other formats for a customer database 202 are possible without detracting from the spirit of the invention.

The invoice database 203 includes for each customer in the customer database 202 a list of invoice entries associated to invoices that are not fully paid. Each invoice entry includes an invoice identifier, an invoice amount and an unpaid amount. Other data elements may also be present in the invoice database without detracting from the spirit of the invention.

The memory also includes a program element 204 for operating on the data 206 for managing a customer's account as well as tools to allow the biller 104 to manage customer invoices in the invoice database 203 and to provide electronic invoice handling capabilities for multiple permission levels.

A typical interaction will better illustrate the functioning of the electronic invoice presentment and payment remittance system 100 and of the program elements 204.

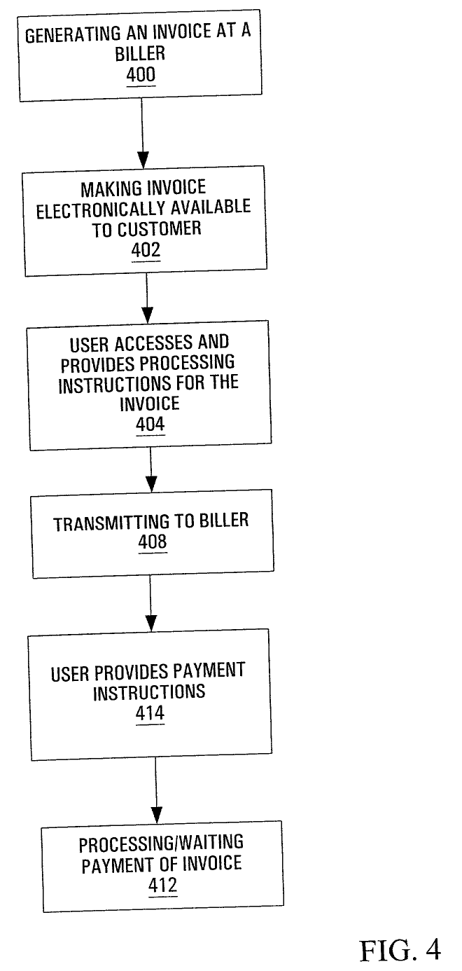

Prior to the use of the electronic invoice presentment and payment remittance system 100, the customer entity 102 registers with the biller entity 104. The registration between the customer entity and the biller entity may be effected over the network 106 or by providing a form to be transmitted by mail, fax or other suitable transmission methods. Registration over the network 106 through a web-based interface will be described herein below with reference to FIG. 3 of the drawings. Registration through the other methods will be readily apparent to the reader skilled in the art. At step 300, a user at the customer site accesses a designated registration website associated with the biller through a network link by providing a network address. This action submits a request for registration of a new customer with the biller entity 104. In response, the customer entity system downloads a registration module implemented by program element 204 (shown in FIG. 2) from the biller computing system 116 to a customer computing unit. The registration module automatically launches to aid the user at the customer site in the completion of the online application for registration. In a specific example of implementation, the registration module is configured to provide step-by-step instructions. At step 302, the user at the customer site fills out a form including various fields related to personal and financial matters, such as company name, address, telephone number, credit card numbers, bank affiliations, and the likes. The user also provides data related to preferred payment methods, a list of authorized user identifiers and passwords as well as the permission level associated to each user identifier. Optionally, permission levels conditioned on the basis the invoice category and/or the privileges defining stages that the user is permitted to complete may also be provided. Some of these information fields may be omitted and others added without detracting from the spirit of the invention. In order to increase security, the user requesting registration at the customer site provides an indication that he (she) is permitted to register the customer with the biller. This may be effected by providing a pre-arranged password at the time of registration, by providing a signed document attesting to this, or by some other means. Once the application for registration is completed at step 303, the application for registration is submitted to the biller entity 104. The registration module facilitates this communication between the customer entity 102 and the biller entity 104. The application form itself, or the registration module, contains the necessary routing information to direct the application over the network 106 to the biller computing system 116. At step 308, the biller entity 104 reviews the application for registration to determine whether the customer entity 102 should be permitted to register and whether any information is missing. If registration is denied, for example information is missing, the customer entity is already registered or the user requesting registration does not have the permission to do so, at step 312 the biller entity 104 returns a message to the customer entity 102 indicating that the application for registration has been denied. Conversely, if the application is granted, the biller entity 104 may return a message indicating that the application for registration is successful.

If the application for registration is granted, at step 310 the biller computing system 116 at the biller entity 104 creates a customer account entry in the customer database 202 including a customer identifier and a plurality of records. Each record associated to the customer identifier includes an authorized user name, password and associated permission level. In a specific implementation, the customer entity entry in the customer database includes at least one record where a first user is associated with a first permission level and a second record where a second user is associated with a second permission level, where the second permission level is distinct from the first permission level. The first permission level allows the first user to process invoices of a first type and the second permission level allowing the second user to process invoices of a second type. Optionally, the permission levels conditioned on the basis the invoice category and/or the privileges defining stages are also included in the records.

A link between the customer account entry in the customer database 202 is associated to an entry in the invoice database 203. In a specific implementation, the program element further provides functionality for allowing a user at the consumer entity to modify the entries in the consumer database such as to add/remove authorized user identifiers, modify passwords, modify permission levels and so on. Following this, the registered customer may handle invoices over the network 106.

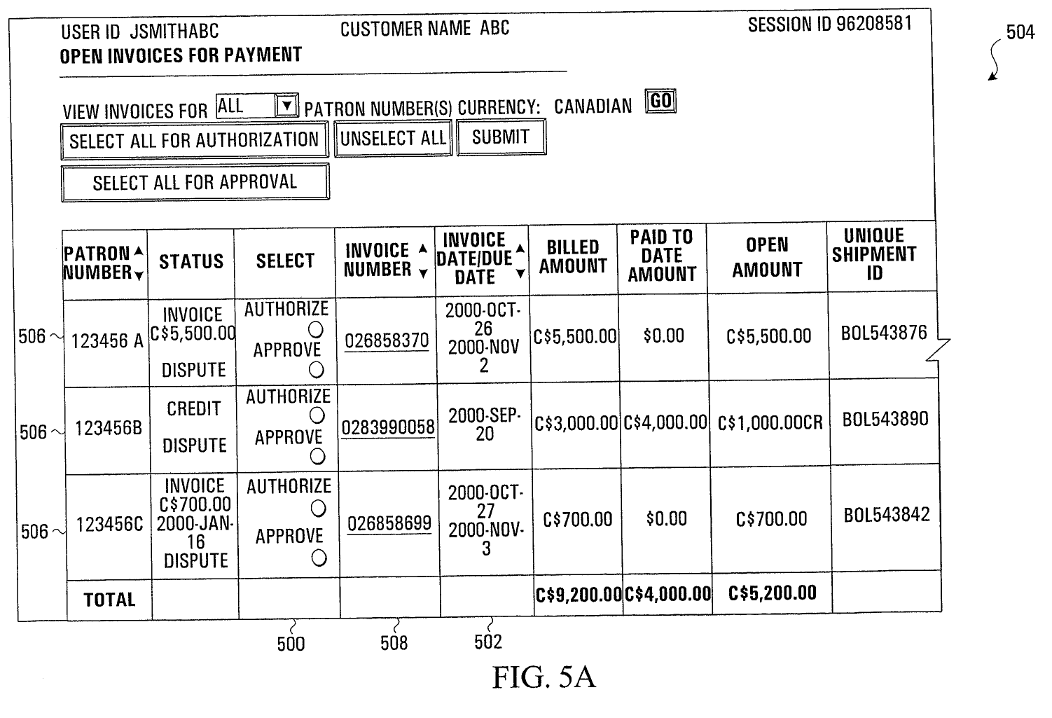

FIG. 4 is a flow diagram of a process for electronically presenting and granting payment of invoices in accordance with specific examples of implementation of the invention.

With reference to FIG. 4, at step 400, the biller computing system 116 generates an invoice at the biller entity. The invoice is stored in the invoice database 203 and is association with a customer account entry in the customer database 202. If the system provide multi-stage invoice handling capabilities, status data elements defining the processing stage of the invoice are also set at this step 400.

At step 402, the invoice is made electronically available to the customer entity.

In a first non-limiting example of implementation, the invoice is transmitted via e-mail to the user at the customer entity having a permission level suitable for processing the invoice. More specifically, the invoice generated at the biller is characterized by a given amount. The given amount is compared with the first range of amounts to determine whether the given invoice is an invoice of a first type associated to a first permission level. In the affirmative, the invoice is transmitted via e-mail to users of the customer entity having the first permission level. The given amount is the compared with the second range of amounts to determine whether the given invoice is an invoice of a second type associated to a second permission level. In the affirmative, the invoice is transmitted via e-mail to users of the customer entity having the second permission level. The same process is repeated for each permission level. In the case of the transmission of an invoice by e-mail, having a graphical user interface conditioned on the basis of the permission levels associated to the users to whom the e-mail is sent will result in fewer e-mail transmissions between the customer entity and the biller. As a variant, the given invoice is characterized by a given category and a given amount. In this variant, the invoice is transmitted via e-mail to the users at the customer entity having a permission level suitable for processing an invoice characterized by the given amount and the given category. In yet another variant, permission levels are further conditioned on the basis the privileges defining stages associated with the user. In this second variant, the invoice is transmitted via e-mail to the users at the customer entity having a permission level suitable for processing an invoice characterized by the given amount, where the permission level corresponds to the processing stage of the invoice.

In this implementation, the invoice is provided as a data structure including various fields modifiable by the user. In a non-limiting example, a field is provided allowing the user to provide payment remittance information credit card information, an authorization to debit a bank account, wire transfer information, direct deposit information or an indication that a check will be mailed.

In a second non-limiting example of implementation, the invoice is made electronically available over network 106 by providing a designated website. In a non-limiting example, the website is a secure website implementing an electronic invoice payment system. Authorized users associated with the customer entity can access the site in order to perform designated tasks. In the second specific example of implementation, the invoice is electronically transmitted over the Internet. In order to view invoices, a user associated to the customer entity access a designated website through a network link by providing a network address in order to view invoices and other account information. The user logs on to the secure website by providing login information including a customer identifier, a login name and a password. The biller computing system received the login information and processes it with respect to the customer database 202. More specifically, the processor 208 accesses the customer database 202 to locate the entry corresponding to the customer identifier. If no corresponding entry is found, an error message is returned to the customer entity. If a corresponding entry is found, the processor 208 attempts to locate a record corresponding to the login name provided. If no corresponding record is found, an error message is returned to the user. If a corresponding record is found, the password in the record is compared to the password provided in the login information. If a match is not found, an error message is returned to the user. If a match is found, the user is successfully identified.

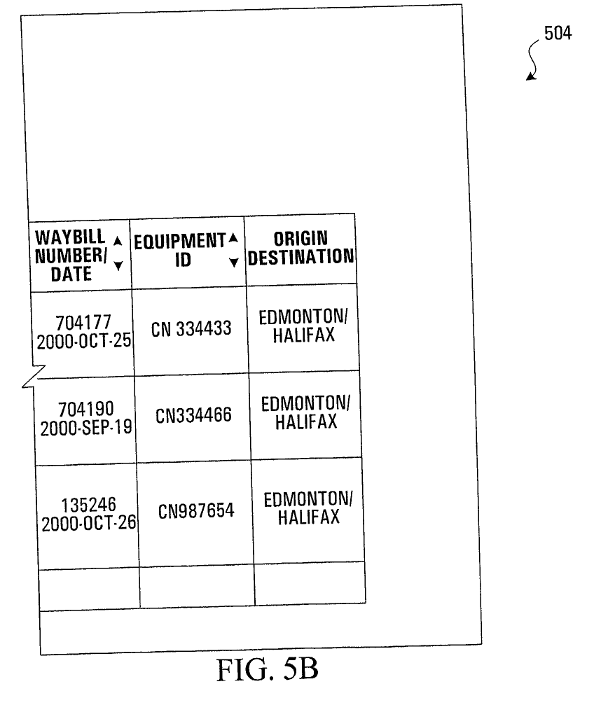

Once the user is successfully identified, the account information in the invoice database 203 corresponding to the customer identifier is transmitted to the user's terminal for display on a graphical user interface at the user's computer terminal. The graphical user interface provides the user with the ability to view one or more outstanding invoices associated with the biller entity 104. FIGS. 5a and 5b of the drawings depicts a graphical user interface showing 3 unpaid invoices in a table 504. Each invoice is depicted as a row 506 in the table 504, each invoice being associated to various information data elements describing characteristics of the invoice. In a non-limiting example, the graphical user interface provides a link for accessing an electronic copy of the complete invoice. In the graphical user interface shown in FIGS. 5a and 5b, this is effected by providing a link associated to the invoice number in the invoice number column 508. When activating a link in the invoice number column 508, a corresponding invoice is displayed to the user at the customer entity site. In a non-limiting implementation, each invoice is provided with a selection column 500 allowing the user to handle an invoice. Each unpaid invoice is displayed with modifiable field based on the permission level associated with the user.

Continuing the typical interaction, at step 404, the user obtains access to the account information in the manner described above, where the user is associated to a first permission level in the customer database. The first permission level allows the user to process invoices of a first type. Once the user has viewed a certain invoice he may process the invoice by approving or authorizing the payment of the invoice and/or issue processing instructions to the biller.

In a first example of implementation, the user enters in column 500 processing instructions for a given invoice by checking a box or filling in a field. At step 408, the instructions are sent to the biller entity over the network 106. The biller entity processes the instructions received from the user. More specifically, the biller system determines whether the user was associated to the appropriate permission level in the customer database 202 to be permitted to issue the instructions. More specifically, the invoice generated at the biller is characterized by a given amount. In a first non-limiting example, for a given invoice corresponding to the customer entity in the invoice database 203, the amount of the given invoice is compared with the range of amounts corresponding permission level associated to the user. If the amount of the given invoice is within the range of amounts, the user is deemed to have a suitable permission level. Otherwise the user is deemed to not have a suitable permission level. If the user does not have a suitable permission level, the biller system will return an error message to the user indicating that the instructions are being disregarded. If the user has a suitable permission level, the biller system will process the instruction received from the user. As a variant, the given invoice is characterized by a given category and a given amount. In this variant, the user has permission levels associated to different categories in the customer database. On the basis of the given category and given amount of the given invoice, if the user has a suitable permission level, the biller system will process the instruction received from the user. In yet another variant, permission levels are further conditioned on the basis the privileges defining stages associated with the user. On the basis of the processing stage of the invoice and given amount of the given invoice, if the user has a suitable permission level, the biller system will process the instruction received from the user.

In a second example of implementation, the graphical user interface is conditioned on the basis of the permission level associated to the user. In a non-limiting example, if the user accessing the system has a permission level N, then only the invoice types that can be processed by a user in that permission level (are) active with the other invoices being deactivated or alternatively being completely absent from the display. Similarly, the graphical user interface may be conditioned on the basis of the permission level associated to the user, the invoice category and the invoice processing stage. The user enters processing instructions for a given invoice by checking a box or filling in a field on the user interface. At step 408, the processing instructions are sent to the biller entity over the network 106. The biller entity processes the instructions received from the user. Since only the invoices that can be processed by the user are active, the biller system, upon receipt of an instruction, does not need to check if the user was permitted to issue processing instructions for this invoice.

In a non-limiting example of implementation, subsequent to the user issuing processing instructions, a payment module automatically launches to aid the user in the completion of the online payment 414. In a specific example of implementation, the payment module is configured to provide step-by-step instructions. The user fills out a form including various fields related to payment instructions. The online payment step 414 may include providing the biller with a credit card number, with an authorization to debit a bank account, wire transfer information, direct deposit information or simply an indication that the check will be mailed on a certain day. The information regarding the payment instructions is submitted to the biller entity over the network 106. The biller entity receives the payment instructions. Alternatively, default payment instructions may be provided by the customer at the time of registration or subsequently indicate a default manner of paying invoices. In this alternative, step 414 may be omitted. In yet another alternative, the payment instructions may be submitted at step 404 as part of the processing instructions.

At step 412, the biller computing system 116 processes or waits for payment of the invoice in a conventional manner on the basis of the payment instructions provided by the customer.

Although the detailed description describes extensively a system for electronically presenting and granting payment of invoices where the invoices are accessible via a web based interface, other embodiments are possible. For example, invoices may be sent to users at the customer entity via electronic mail, the users having suitable permission levels for processing the invoices. At the customer site, the users open the received electronic mail and the account information contained therein is displayed on a graphical user interface on the users' computer terminals. The handling of the invoice at the biller site may be effected in a similar fashion as that described above.

Although the present invention has been described in considerable detail with reference to certain preferred embodiments thereof, variations and refinements are possible without departing from the spirit of the invention. Therefore, only the appended claims and their equivalents should limit the scope of the invention.

1) A method for handling an invoice generated at a biller and destined to a customer entity, the customer entity including a first user and a second user, said method comprising:
a) providing at the biller a first permission level and associating the first permission level to the first user, said first permission level allowing the first user to process invoices of a first type;
b) providing at the biller a second permission level and associating the second permission level to the second user, said second permission level allowing the second user to process invoices of a second type;
c) enabling either one of the first user and the second user on the basis of their associated permission levels to process over a network the given invoice.

2) A method for handling a given invoice generated at a biller and destined to a customer entity, the given invoice being characterized by a given amount, the customer entity including a first user and a second user, said method comprising:
a) providing a first permission level and associating said first permission level to the first user, said first permission level allowing the first user to process invoices of a first type characterized by amounts in a first range of amounts;
b) providing a second permission level and associating said second permission level to the second user, said second permission level allowing the second user to process invoices of a second type characterized by amounts in a second range of amounts;
c) comparing the given amount with the first range of amounts to determine whether the given invoice is an invoice of the first type;
d) enabling the first user to enter processing instructions for transmission to the biller for the given invoice if the result of the comparison in c) indicates that the given invoice is an invoice of the first type;
e) comparing the given amount with the second range of amounts to determine whether the given invoice is an invoice of the second type;
f) enabling the second user to enter processing instructions for transmission to the biller for the given invoice if the result of the comparison in e) indicates that the given invoice is an invoice of the second type.

3) A method as defined in claim 2, wherein:
a) the first range of amounts has a first lower boundary amount and a first upper boundary amount;
b) the second range of amounts has a second lower boundary amount and a second upper boundary amount, where the second upper boundary amount is greater than the first upper boundary amount.

4) A method as defined in claim 3, wherein the first range of amounts and the second range of amounts are non-overlapping.

5) A method as described in claim 2, said method further comprising:
a) enabling the first user to provide payment remittance information for the given invoice if the given invoice is an invoice of the first type;
b) enabling the second user to provide payment remittance information for the given invoice if the given invoice is an invoice of the second type;
wherein the payment remittance information includes data selected from the set consisting of a credit card number, an authorization to debit a bank account, wire transfer information, direct deposit information, an amount to be paid on the invoice and an indication that a check will be mailed.

6) A method as described in claim 2, wherein the given invoice is associated to a given category selected from a plurality of categories, the first and second users having respective permission levels associated to respective categories.

7) A method as described in claim 2, wherein the first and second users have respective permission levels associated to respective stages of a multi-stage invoice handling process.

8) A computer readable medium comprising a program element suitable for execution by a computing apparatus for handling an invoice over a network, the invoice being issued by a biller entity to a customer entity, said computing apparatus comprising:
a) a memory unit for storing an entry associated to the customer entity, the entry including:
i) a first record associated to a first user of the customer entity and including a data element indicative of a first permission level, said first permission level allowing the first user to process invoices of a first type;
ii) a second record associated to a second user of the customer entity and including a data element indicative of a second permission level, said second permission level allowing the second user to process invoices of a second type;
b) a processor operatively connected to said memory unit, said program element, when executing on said processor, being operative for:
i) generating a given invoice at the biller;
ii) enabling either one of the first user and the second user on the basis of their associated permission levels to process over a network the given invoice.

9) A computer readable medium comprising a program element suitable for execution by a computing apparatus for handling an invoice over a network, the invoice being issued by a biller entity to a customer entity, said computing apparatus comprising:
a) a port for exchanging messages with a customer entity residing in a remote location, the customer entity including a first computing unit and a second computing unit, the first computing unit being associated to a first user and the second computing unit being associated to a second user;
b) a memory unit for storing an entry associated to the customer entity, the entry including:
i) a first record associated to the first user of the customer entity and including a data element indicative of a first permission level, said first permission level allowing the first user to process invoices of a first type characterized by a first range of amounts;
ii) a second record associated to the second user of the customer entity and including a data element indicative of a second permission level, said second permission level allowing the second user to process invoices of a second type characterized by a second range of amounts;
c) a processor operatively connected to said memory unit and said port, said program element, when executing on said processor, being operative for:
i) generating a given invoice at the biller, the given invoice being characterized by a given amount;
ii) comparing the given amount with the first range of amounts to determine whether the given invoice is an invoice of the first type;
iii) enabling the first user to enter processing instructions encoded in messages transmitted to the biller for the given invoice if the given amount is in the first range of amounts;
iv) comparing the given amount with the second range of amounts to determine whether the given invoice is an invoice of the second type;
v) enabling the second user to enter processing instructions encoded in messages transmitted to the biller for the given invoice if the given amount is in the second range of amounts.

10) A computer readable medium as defined in claim 9, wherein:
a) the first range of amounts has a first lower boundary amount and a first upper boundary amount;
b) the second range of amounts has a second lower boundary amount and a second upper boundary amount, where the second upper boundary amount is greater than the first upper boundary amount.

11) A computer readable medium as defined in claim 10, wherein the first range of amounts and the second range of amounts are non-overlapping.

12) A computer readable medium as described in claim 9, wherein the program element is further operative for:
a) enabling the first user to provide payment remittance information for the given invoice if the given invoice is an invoice of the first type;
b) enabling the second user to provide payment remittance information for the given invoice if the given invoice is an invoice of the second type;
wherein the payment remittance information includes data selected from the set consisting of a credit card number, an authorization to debit a bank account, wire transfer information, direct deposit information, an amount to be paid on the invoice and an indication that a check will be mailed.

13) A computer readable medium as described in claim 9, wherein the given invoice is associated to a given category selected from a plurality of categories, the first and second users having respective permission levels associated to respective categories.

14) A computer readable medium as described in claim 9, wherein the first and second users have respective permission levels associated to respective stages of a multi-stage invoice handling process.

15) An electronic invoice presentment and payment remittance system including:
a) a biller computing unit with computer-readable medium;
b) a first customer computing unit with computer readable medium, the first customer computing unit being associated to a first user;
c) a second customer computing unit with computer readable medium, the second customer computing unit being associated to a second user;
the computer-readable media having computer-executable instructions for:
i) providing a first permission level and associating the first permission level to the first user, said first permission level allowing the first user to process invoices of a first type;
ii) providing a second permission level and associating the second permission level to the second user, said second permission level allowing the second user to process invoices of a second type;
iii) operatively linking over a network the biller computing unit and at least one of said first and second customer computing units;
iv) generating an invoice at the biller computing unit;
v) selectively allowing either one of the first user and the second user to enter processing instructions for the given invoice on the basis of their associated permission levels;
vi) routing the processing instructions entered in v) to the biller computing unit.

16) An electronic invoice presentment and payment remittance system including:
a) a biller computing unit with computer-readable medium;
b) a first customer computing unit with computer readable medium, the first customer computing unit being associated to a first user;
c) a second customer computing unit with computer readable medium, the second customer computing unit being associated to a second user;
the computer-readable media having computer-executable instructions for:
i) providing a first permission level and associating the first permission level to the first user, said first permission level allowing the first user to process invoices of a first type characterized by a first range of amounts;
ii) providing a second permission level and associating the second permission level to the second user, said second permission level allowing the second user to process invoices of a second type characterized by a second range of amounts;
iii) operatively linking over a network the biller computing unit and at least one of said first and second customer computing units;
iv) generating a given invoice at the biller computing unit, the given invoice being characterized by a given amount;
v) comparing the given amount with the first range of amounts to determine whether the given invoice is an invoice of the first type;
vi) enabling the first user to enter processing instructions for the given invoice if the result of the comparison in v) indicates that the given invoice is an invoice of the first type;
vii) comparing the given amount with the second range of amounts to determine whether the given invoice is an invoice of the second type;
viii) enabling the second user to enter processing instructions for the given invoice if the result of the comparison in vii) indicates that the given invoice is an invoice of the second type;
ix) routing the processing instructions to the biller computing unit.

17) A system as defined in claim 16, wherein:
a) the first range of amounts has a first lower boundary amount and a first upper boundary amount;
b) the second range of amounts has a second lower boundary amount and a second upper boundary amount, where the second upper boundary amount is greater than the first upper boundary amount.

18) A system as defined in claim 17, wherein the first range of amounts and the second range of amounts are non-overlapping.

19) A system as described in claim 16, the computer-readable media having computer-executable instructions for:
a) enabling the first user to provide payment remittance information for the given invoice if the given invoice is an invoice of the first type;
b) enabling the second user to provide payment remittance information for the given invoice if the given invoice is an invoice of the second type;
wherein the payment remittance information includes data selected from the set consisting of a credit card number, an authorization to debit a bank account, wire transfer information, direct deposit information, an amount to be paid on the invoice and an indication that a check will be mailed.

20) A system as described in claim 16, wherein the given invoice is associated to a given category selected from a plurality of categories, the first and second users having respective permission levels associated to respective categories.

21) A system as described in claim 16, wherein the first and second users have respective permission levels associated to respective stages of a multi-stage invoice handling process.

22) A method for handling a given invoice generated at a biller and destined to a customer entity, the given invoice being characterized by a given amount, said method comprising:
a) providing a plurality of permission levels and associating the permission levels to respective users of the customer entity, each permission level allowing the associated user to process invoices characterized by amounts in a range of amounts;
b) for a given permission level, comparing the given amount with the range of amounts corresponding to the given permission level to determine whether the given permission level allows processing of the given invoice;
c) enabling either one of the users in said plurality of users to enter processing instructions for the given invoice on the basis of the comparisons in b).
